(19) United States
(12) Patent Application Publication
(10) Pub. No.: US 2009/0121849 A1
(43) Pub. Date: May 14, 2009

(54) Vehicular Computer System With Independent Multiplexed Video Capture Subsystem

(76) Inventor: John Whittaker, Seguin, TX (US)

Correspondence Address: GUNN & LEE, P.C., 700 N. ST. MARY'S STREET, SUITE 1500, SAN ANTONIO, TX, 78205, US

(21) Appl. No.: 11/939,278

(22) Filed: Nov. 13, 2007

(51) Int. Cl. B60Q 1/00; H04N 7/18

(52) U.S. Cl. 340/425.5; 348/148

(57) ABSTRACT

A vehicular computer system comprising a primary processing subsystem adapted to provide a first graphics output stream; a video capture subsystem adapted to provide a second graphics output stream; a storage multiplexer connected to the primary processing subsystem and the video capture subsystem; and non-volatile storage accessible through the storage multiplexer by the primary processing subsystem and the video capture subsystem. Another aspect of the present invention comprises an enclosure housing these elements and a display means defining a portion of the exterior surface of the enclosure.

### CROSS REFERENCE TO RELATED APPLICATIONS

Not applicable.

### BACKGROUND OF THE INVENTION

1. Field of the Invention

The present invention relates to a vehicular computer system. More specifically, the invention is a system that incorporates independent multiplexed video capture and is specifically designed to integrate the vital components of law enforcement and other emergency response agencies into a single enclosure.

2. Description of the Related Art

Modern emergency vehicles incorporate many different aspects of technology to make the job of the typical emergency responder easier and to insure both efficiency and effectiveness in law enforcement. For example, almost every police cruiser now includes a visor-mounted camera for recording events that occur during patrol, such as high-speed chases or confrontations with recalcitrant motorists. In addition to a visor-mounted camera, police cruisers typically contain a variety of radio and other communication equipment, such as cellular phone transceivers and antennas. The typical police cruiser also includes a computer system that can access the department database to perform background checks, warrant searches, and related functions.

In the prior art, these various components are usually strung together with large amounts of communication and power cables in an effort to allow each of the various technology components to interface with each other, which results in several disadvantages. First, the use of many separate components requires a great deal of a vehicle's space. Second, care must be taken by the responder (and the passengers) because the interface and power cables are often exposed and, while care may be taken to secure such cables within the vehicle, that they are inadvertently dislodged and disconnected is almost inevitable during regular operation of the vehicle. Perhaps most importantly, these mish-mash systems are not self-contained, which means that if one component or interconnection fails, it is often very difficult to quickly isolate and replace or repair the problematic component or cable, which often results in the vehicle itself being unusable.

Moreover, because the typical prior art vehicle computer systems use interconnected yet independently designed and manufactured components, those components are not optimized to function with each other to address the special needs of law enforcement or other emergency response agencies. For example, the video capture system will often function separately from the computer system and, as a result, the computer system may handle the video stream from the video capture either inefficiently or not at all. Typically, the video capture system is located in the trunk of the vehicle or overhead near the rear view mirror, while the computer system is placed centrally in the passenger compartment, thus requiring the video capture system to communicate with the computer system through some external communications interface like USB or IEEE 1394. These are extremely inefficient and demanding communication methods that reduce the effectiveness of the computer system.

Capturing video in a manner by which the captured video is immediately accessible to, yet still independent of, the vehicle's computer system, as opposed to having a separate video capture subsystem, has the important advantage of allowing the system to access the video directly for preview, review, playback and incorporation within response reports while not compromising the performance or integrity of the system. In addition, there would be an advantage gained by the sharing of certain resources.

### BRIEF SUMMARY OF THE INVENTION

The present invention is a vehicular computer system that provides independent multiplexed video capture. The system incorporates a primary processing subsystem adapted to provide a first graphics output stream; a video capture subsystem adapted to provide a second graphics output stream; non-volatile storage accessible through a storage multiplexer by the primary processing subsystem and the video capture subsystem; a display multiplexer subsystem; an enclosure housing the primary processing subsystem, the video capture subsystem, the storage multiplexer, the display multiplexer subsystem, and the non-volatile storage; and a display means connected to the display multiplexer means for display of a multiplexed graphics output stream and defining a portion of the exterior surface of the enclosure.

The present invention is particularly useful in capturing and viewing video streams. For example, according to one feature of the invention, when a first graphics input stream is received from an audio/video input device (e.g., a visor-mounted camera) by the video capture subsystem, first graphics input data representative of the first graphics input stream is stored in non-volatile storage accessible either through the storage multiplexer or the internal ethernet interface by the primary processing subsystem. When a user desires to access the stored data, the primary processing subsystem retrieves the data and provides the data to a display multiplexer subsystem adapted to display the stored stream, a live stream, or some combination of both to the display means.

### BRIEF DESCRIPTION OF THE SEVERAL VIEWS OF THE DRAWING

The present invention, as well as further objects and features thereof, are more clearly and fully set forth in the following description of the preferred and alternative embodiments, which should be read with reference to the accompanying drawings, wherein:

FIG. 1 is a block diagram disclosing the functional relationship between the elements of the preferred embodiment of the present invention;

FIG. 2 is a block diagram disclosing the functional relationship between the elements of a first alternative embodiment of the present invention;

FIG. 3 is a block diagram showing the video capture subsystem of the first alternative embodiment of the present invention;

FIG. 4 is a block diagram illustrating the primary processing subsystem of the first alternative embodiment of the present invention;

FIG. 5 is a block diagram showing the display multiplexer subsystem of the first alternative embodiment of the present invention;

FIG. 6 is a frontal isometric view of the first alternative embodiment of the present invention;

FIG. 7 is a rear isometric view of the first alternative embodiment of the present invention;

FIGS. 8A and 8B are exploded rear isometric views of the first alternative embodiment showing orientation of the internal components of the system in greater detail;

FIG. 9A and FIG. 9B are a flowchart and flow diagram, respectively, of a method of the present invention;

FIG. 10A and FIG. 10B are a flowchart and flow diagram, respectively, of a method for managing two graphics input streams; and

FIG. 11A and FIG. 11B are a flowchart and flow diagram, respectively, wherein the storing step comprises the additional steps of storing data to a circular buffer.

### DETAILED DESCRIPTION OF THE PREFERRED EMBODIMENT

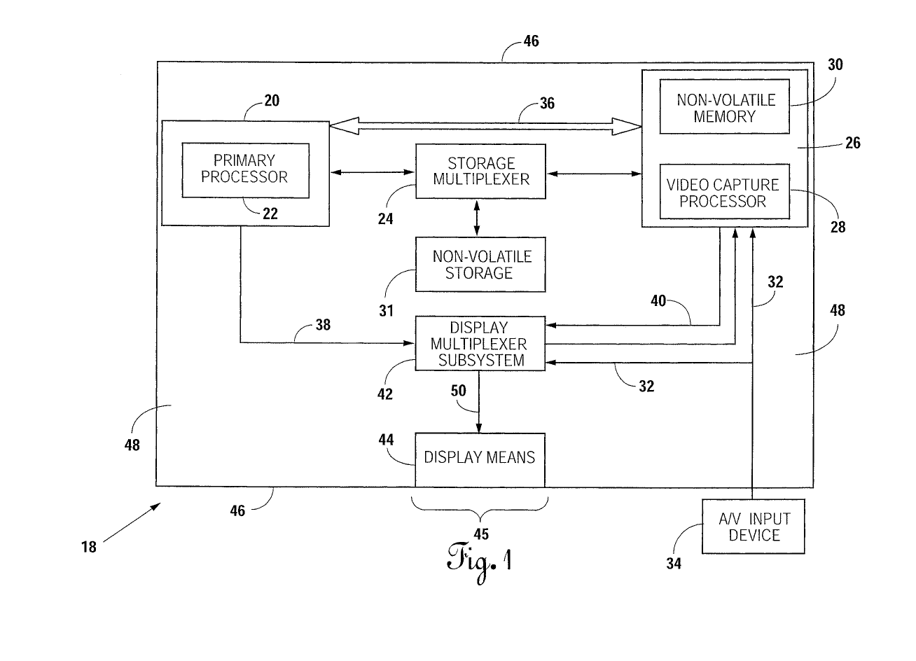

As shown in FIG. 1, a block diagram of the preferred embodiment of the system 18, the present invention comprises a primary processing subsystem 20 having a primary processor 22, a storage multiplexer 24, and a video capture subsystem 26 having a video capture processor 28 and non-volatile memory 30. Non-volatile storage 31 is accessible by either the primary processing subsystem 20 or the video capture subsystem 26 through the storage multiplexer 24. Because of the intensive computing requirements of handling a video input stream 32 from an audio/video (A/V) input device 34 (e.g., a video camera), by receiving the video input stream 32 into the video capture subsystem 26, the primary processor subsystem 20 is left relatively unburdened to handle the other functions of the system 18. In the preferred embodiment of the system 18, the primary processor 22 is preferably a 90 nM Pentium-M having 2 MB of L2 cache and operating at a clock speed of between 1.4 to 2.0 GHz. The video capture processor 28 is preferably an AMD Geode SC1200 operating at a clock speed of 266 MHz. In either case, however, similar processors may be used, as will be understood by those having ordinary skill in the art.

The primary processing subsystem 20 and video capture subsystem 26 are in communication via a direct communication path 36 that includes one or more of ethernet, PCI, I²C, or discrete digital semaphore interfaces. In addition, the primary processing subsystem 20 and video capture subsystem 26 include all necessary interfacing and other circuitry to support operation of the primary processor 22 and video capture processor 28, respectively, and their functionality. For example, the video capture subsystem 26 includes the necessary circuitry to receive the video input stream 32 from the audio/video input device 34 (e.g., ITU-656 interfacing components), which circuitry is known to those having skill in the art.

Both the primary processing subsystem 20 and the video capture subsystem 26 are adapted to provide a first graphics output stream 38 and a second graphics output stream 40, respectively, to a display multiplexer subsystem 42. The display multiplexer subsystem 42 is adapted to provide a third graphics output stream 50 to the display means 44, which third graphics output stream 50 may comprise the first graphics output stream 38, the second graphics output stream 40, or some combination thereof. The display multiplexer subsystem 42 is connected to a display means 44 for receiving a multiplexed graphics output stream and defining a portion 45 of the exterior surface 46 of an enclosure 48 housing the primary processing subsystem 20, the video capture subsystem 26, the storage multiplexer 24, and the non-volatile storage 31. In the preferred embodiment, the display means 44 is a 12.1-inch XGA LCD TFT display.

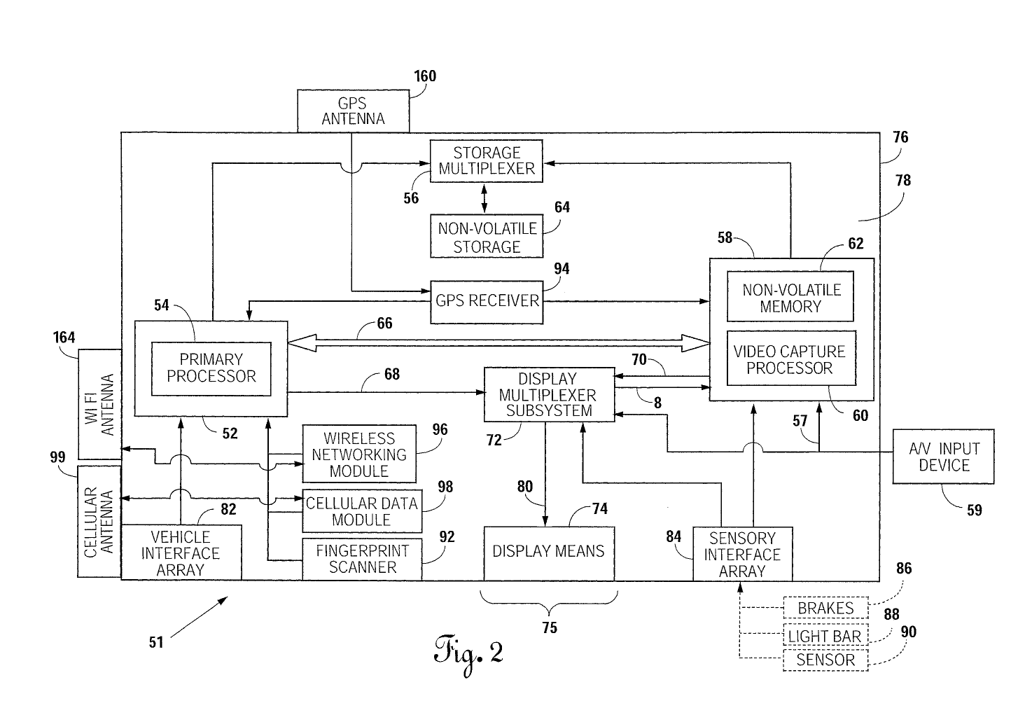

FIG. 2 shows a system block diagram of a first alternative embodiment of the present invention. As previously disclosed with respect to FIG. 1, the first alternative embodiment also comprises a primary processing subsystem 52 having a primary processor 54, a storage multiplexer 56, and a video capture subsystem 58 having a video capture processor 60 and non-volatile memory 62. Non-volatile storage 64 is accessible by either the primary processing subsystem 52 or the video capture subsystem 58 through the storage multiplexer 56. Because of the intensive computing requirements of handling a video input stream 57 from an A/V input device 59, by receiving the video input stream 57 into the video capture subsystem 58, the primary processor subsystem 52 is left relatively unburdened to handle the other functions of the system 51.

The primary processing subsystem 52 and video capture subsystem 58 are in communication over a direct communication path 66 that includes one or more of ethernet, PCI, I²C, or discrete digital semaphore interfaces. In addition, the primary processing subsystem 52 and video capture subsystem 58 include all necessary interfacing and other circuitry to support operation of the primary processor 54 and video capture processor 60, respectively, and such circuitry is known to those having ordinary skill in the art.

Both the primary processing subsystem 52 and the video capture subsystem 58 are adapted to provide a first graphics output stream 68 and a second graphics output stream 70, respectively, to a display multiplexer subsystem 72. The display multiplexer subsystem 72 is connected to a display means 74 for receiving a multiplexed graphics output stream and defining a portion 75 of the exterior surface 76 of an enclosure 78 housing the primary processing subsystem 52, the video capture subsystem 58, the storage multiplexer 56, and the non-volatile storage 64. The display multiplexer subsystem 72 is adapted to provide a third graphics output stream 80 to the display means 74, which third graphics output stream 80 may comprise the first graphics output stream 68, the second graphics output stream 70, or some combination thereof. In the first alternative embodiment, the display means 74 is a 12.1-inch XGA TFT LCD.

The display multiplexer subsystem 74 also receives the video input stream 57 from the A/V input device 59. Thereafter, the display multiplexer subsystem 72 may selectively provide a second graphics input stream 81 to the video capture subsystem 58 for storage within the non-volatile memory 62. The second graphics input stream 81 may have information overlaid by an on-screen display processer within the display multiplexer subsystem 72, as will be described in greater detail hereinafter.

Still referring to FIG. 2, a vehicle interface array 82 is connected to the primary processing subsystem 52 to provide for general input/output. For example, the vehicle interface array 82 may provide for operation of the system 51 with other peripherals via IEEE 1394, SATA, USB, ethernet, or other industry-standard interfaces. In addition, the vehicle interface array 82 provides communication for standard user input peripherals such as mouse, keyboard, and serial communications ports.

The first alternative embodiment further comprises a sensory interface array 84 connected to the video capture subsystem 58. The sensory interface array 84 provides for input from various external sources, such when vehicle brakes 86 are activated, when the vehicle's light bar 88 is actuated, or when another sensor 90 provides an input signal. The sensory interface array 84 is coupled to the display multiplexer subsystem 72 so that information representing received sensory input (e.g., indicating actuation of a light bar) can be overlayed on the third graphics output stream 80.

The first alternative embodiment of the system 51 further includes a fingerprint scanner 92 connected to the primary processing subsystem 52 and integrated into the outer surface 76 of the enclosure 78. The fingerprint scanner 92 provides the functionality to uniquely recognize an individual based on his or her fingerprints, and may be used as a security measure to prevent operation of the system 51 by unauthorized persons or to identify a person in the custody or care of a responder.

A GPS receiver 94 is connected to the primary processing subsystem 52 to receive a global positioning signal 95 from GPS satellites through a GPS antenna 160 extending from the enclosure. The system 51 further provides a wireless networking module 96 and connected wi-fi antenna 164 and cellular data module 98 and connected cellular antenna 99 connected to the primary processing subsystem 52 for alternative communication over wi-fi or cellular networks. For example, the system 51 may access a remote fingerprint database in conjunction with use of the fingerprint scanner 92 to identify a person in custody of the responder. In addition, the system 51 may be configured to automatically download or upload information (e.g., captured video) upon return to a station. These technologies are generally known in the art.

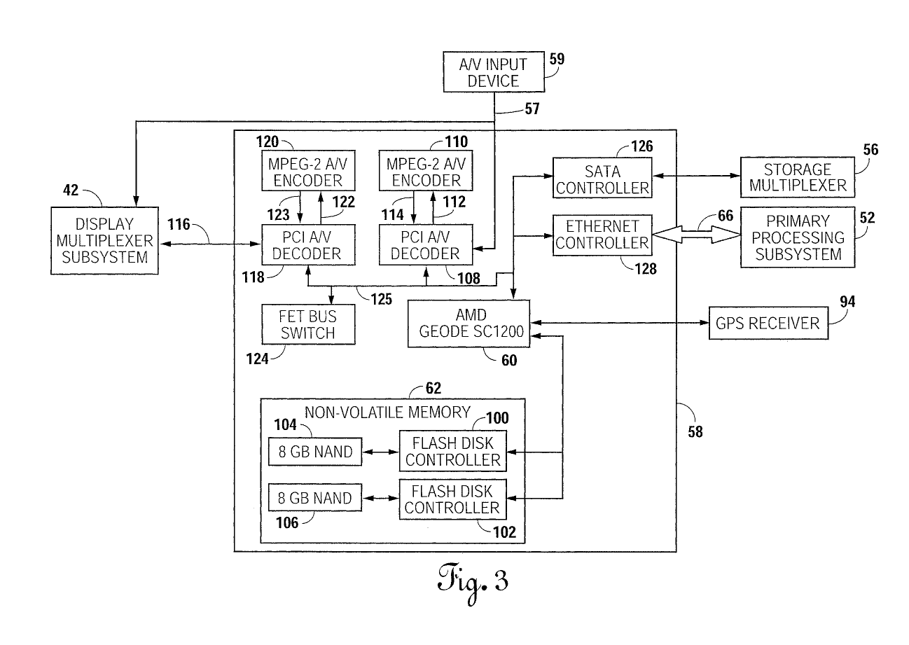

FIG. 3 more fully discloses the functional components of the video capture subsystem 58 of the first alternative embodiment of the present invention. The primary processor 60, preferably an AMD Geode SC1200 is connected to the non-volatile memory 62 including a primary flash disk controller 100 and a secondary flash disk controller 102. The primary flash disk controller 100 provides access to and from a primary flash disk 104, while the secondary flash disk controller 102 provides access to and from a secondary flash disk 106. Incorporating the non-volatile memory 62 into the video capture subsystem 58 allows stored data to be retrieved after a critical failure to the system, such as power failure. The non-volatile memory is preferably 8 GB NAND flash, but various sizes and types of such memory may be used in other alternative embodiments of the system.

In the first alternative embodiment, the graphics input stream 57 received from the A/V input device 59 is directed to a primary audio/visual (A/V) decoder 108. A primary A/V encoder 110 receives the captured video from the primary decoder 108 via a ITU-656 interface 112 and returns the video compressed in MPEG-2 format 114. Similarly, a graphics input stream 116 may also be received by a secondary A/V decoder 118 from the display multiplexer subsystem 42. The secondary A/V encoder 120 receives the captured video from the secondary decoder 118 via an ITU-656 interface 122 and returns the video compressed in MPEG-2 format 123. In the preferred embodiment, it should be noted that in the preferred embodiment that the primary and secondary decoders 110, 118 perform not only analog-to-digital conversion of any received graphics input stream, but also provide the MPEG-2 compressed streams received form the primary and secondary decoders 110, 120 to the PCI bus. The primary and secondary decoders 108, 118 are preferably SAA 7134HL decoders manufactured by Philips, while the primary and secondary encoders 110, 120 are preferably SAA 6752HS encoders, also manufactured by Philips. The FET bus switch 124, primary and secondary decoders 108, 118, ethernet controller 128, and SATA controller or connected to the video capture processor 60 of a PCI bus 125. In addition, the FET bus switch 124 provides a direct communication interface (not shown) from the video capture subsystem 58 to the primary processing subsystem 52

Still referring to FIG. 3, the video capture subsystem 58 of the first alternative embodiment further includes a SATA controller 126 providing the video capture processor 60 accessibility to the non-volatile storage 64 (not shown) via the storage multiplexer 56. An ethernet controller 128 allows the video capture processor 60 to communicate with the primary processing subsystem 52 over the ethernet communication link 66. The GPS receiver 94 provides input to the video capture subsystem 58, which input may be overlaid on the graphics output stream (not shown) or stored in memory for later use.

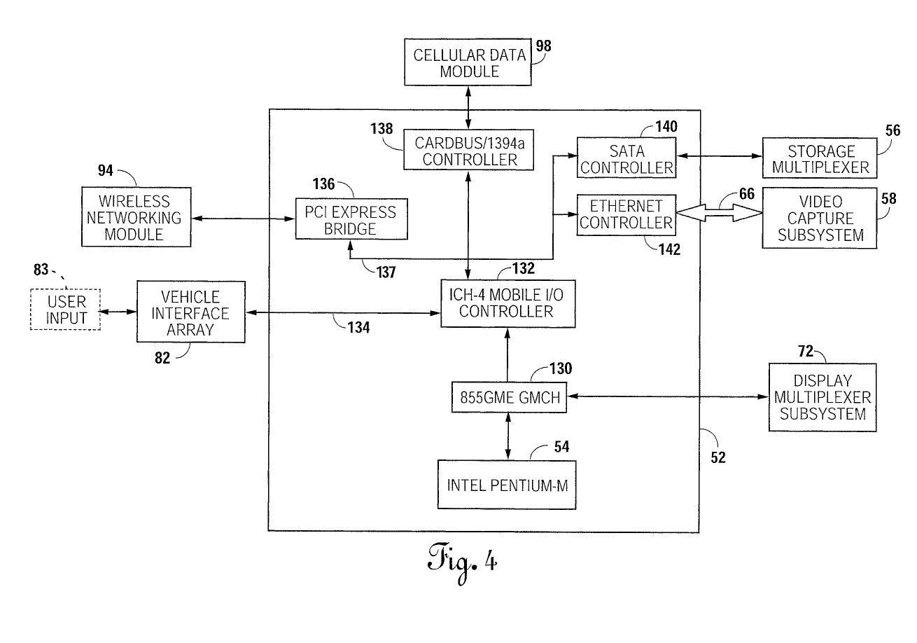

As shown in FIG. 4, the primary processing subsystem 52 of the first alternative embodiment includes the primary processor 54, which is preferably an Intel Pentium-class processor, connected to a memory controller hub 130 that is preferably an Intel 855GME. The memory controller hub 130 provides accessibility to the display multiplexer subsystem 72 and to various other subsystem components through an I/O controller 132, such as an ICH-4 Mobile I/O Controller manufactured by Intel.

The I/O controller 132 provides the coupling 134 to the vehicle interface array 82, which accepts user input 83 via any variety of interfaces (e.g., IEEE 1394, mouse, keyboard, serial communications, etc.). In addition, the I/O controller 132 is connected to a PCI bridge 136 interfaced with the wireless networking module 94 and a SATA controller 140 providing accessibility of the primary processing subsystem 52 to the non-volatile storage 64 (not shown) via the storage multiplexer 56. The I/O controller 132 also interfaces with cardbus controller 138 to provide accessibility to cellular data networks via the cellular data module 98. The I/O controller 132 is also coupled to ethernet controller 142 to allow communication with the video capture subsystem 58 via the ethernet communication link 66. The connection between the PCI bridge 136, cardbus controller 138, SATA controller 140, and ethernet controller 142 is over a PCI bus 137.

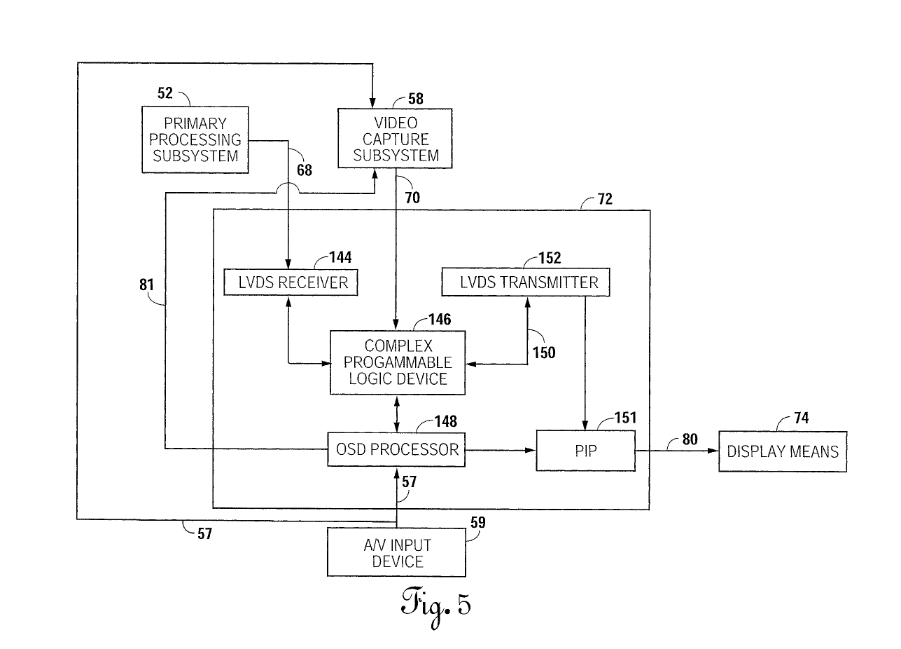

FIG. 5 discloses in more detail the display multiplexer subsystem 72 of the first alternative embodiment. The primary processing subsystem 52 interfaces with a low voltage differential signal (LVDS) receiver 144, which, in turn, provides coupling to a programmed complex programmable logic device 146. The video capture subsystem 58 is coupled directly to the complex programmable logic device 146 to provide on screen display functionality such as integrated graphics and/or text over the first graphics output stream 68 and/or second graphics output stream 70 (e.g., indicating radar speed, whether a light bar is activated, GPS positioning information, etc.). In addition, an on screen display (OSD) processor 148 interfaces with the complex programmable logic device 146. The complex programmable logic device 146 is configured, as is known to those having ordinary skill in the art, to provide the multiplexing capability to route a multiplexed video stream 150 to LVDS transmitter 152. Both the OSD processor 148 and LVDS transmitter 152 provide output to a picture-in-picture circuit 151 for ultimate provision of a third graphics output stream 80 to the display means 74. The OSD processor 148 also selectively provides a second input stream 81 to the video capture subsystem 58, which second input stream 81 comprises the received graphics input stream 57 with whatever desired graphics are overlaid thereon by the OSD processor 148. The second graphics input stream 81 may thereafter be stored for later retrieval.

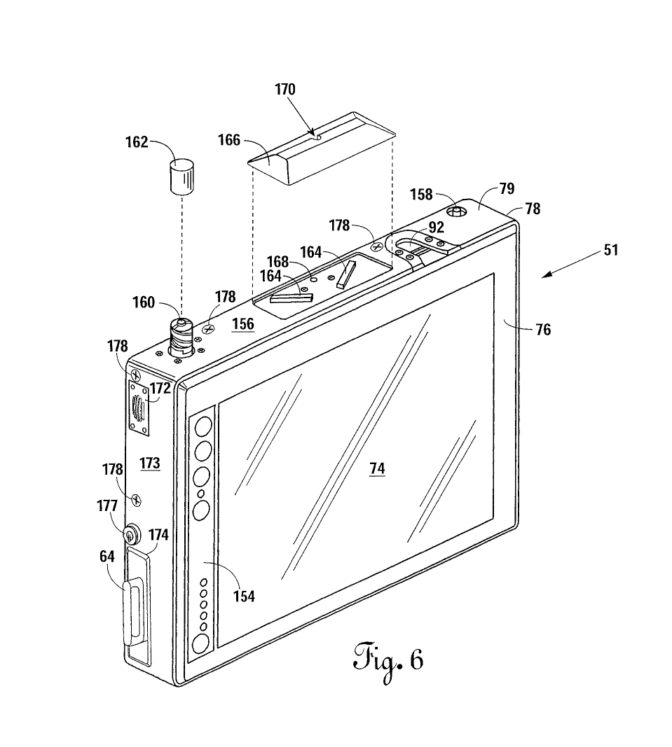

FIG. 6 and FIG. 7 show frontal and rear isometric views, respectively, of the first alternative embodiment of the system 51 as would be installed in a typical emergency response vehicle. The display surface 74 defines a portion of the exterior surface 76 of the enclosure 78. An indicator panel 154 adjacent the display surface 74 notifies the responder of the status of various system properties, such as communications, power, battery, and storage status.

To enable communication to and from the system 51, the enclosure 78 provides for placement of various communication antenna along a top surface 156 thereof. A GPS antenna 160 protrudes through top surface 156 to receive GPS signals from satellites and is protected by a plastic GPS antenna cover 162. A cellular antenna port 158 also protrudes through the top surface 156 for attachment to a cellular antenna (not shown).

Two wireless networking antennas 164 also are affixed to the top surface 156 and oriented substantially transversely to each other to maximize effectiveness. A plastic antenna cover 166 is securable to the enclosure to protect the wireless networking antennas 164 from the environment while not impeding their ability to transmit or receive wireless signals. During operation, light from an LED 168 disposed through the top surface 156 is directed into a channel 170 formed in the rear of the plastic antenna cover 166. The LED 168 is used to indicate system status by, for example, illuminating with a predetermined frequency corresponding to operation of the system 51. For example, in the first preferred embodiment, the LED 168 is illuminated while the A/V input device is actuated, thus allowing the responder to ensure operation of the A/V input device while outside the vehicle. Light emanating from the LED is visible through the channel 170 in the antenna cover 166.

In addition to the various communication antennas and ports, other features of the present invention are integrated into exterior surface 76 of the enclosure 78. The fingerprint scanner 92 is integrated into the top surface 156. A speaker cover 172 is mounted on to a first side surface 173 of the enclosure 78 to protect an internally mounted speaker (not shown). A removable storage bay 174 houses the non-volatile storage 64, which may be a hard disk drive or flash drive and is lockable using a lock 177 also disposed through the first side surface 173. A plurality of mounting screws 178 are disposed through the first side surface 173 affix the enclosure 78 to an internal vented bulkhead (not shown), as will be described hereinafter.

As shown in FIG. 7, a ribbed back panel 180 of the enclosure is secured to the main body 79 of the enclosure 78 using screws 183. The back panel 180 is shaped to provide an airflow pathway to the interior of the enclosure 78 so that an attached fan 182 may force air therethrough to cool the electrical components contained within the enclosure 78. The back panel 174 is metallic to facilitate heat dissipation. The vehicle interface array 82 and sensory interface array 84, which provide external connectivity to the user I/O devices and various sensors, are accessible through two connector ports 184 disposed through the back panel 174.

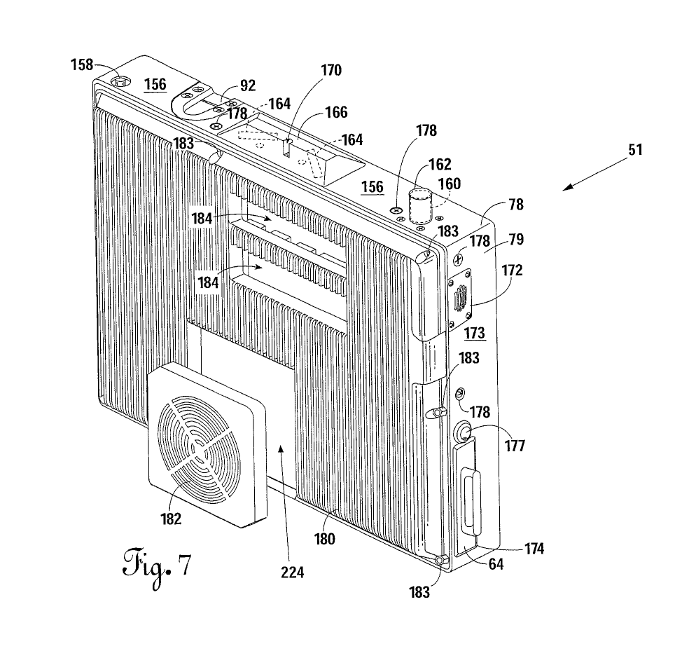

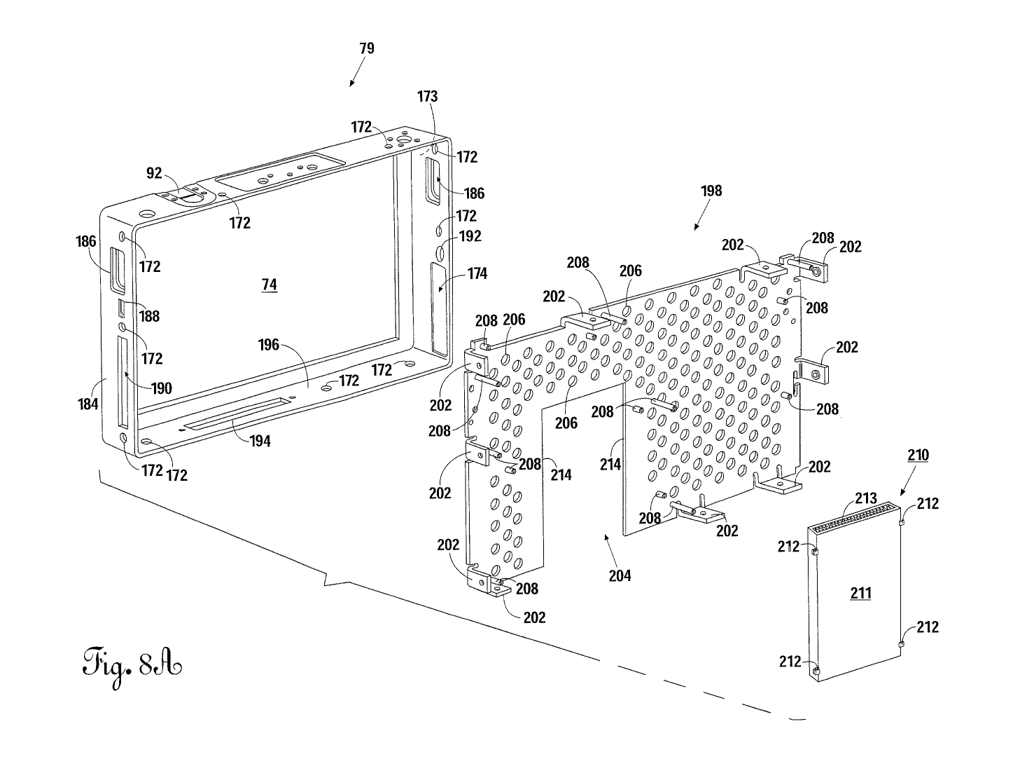

As shown in FIG. 8A, the first side surface 173 and a second side surface 184 each provide a speaker mounting hole 186. The second side surface 184 also provides a USB interface slot 188 and a card slot 190 for insertion of a PCMCIA card (not shown). The removable storage bay 174 and lock hole 192 are also disposed in the first side surface 173 of the enclosure body 79. An air intake slot 194 is disposed through a bottom surface 196 of the body 79.

A plurality of mounting holes 172 disposed through the body 79 provide for attachment of a vented bulkhead 198 by securing mounting screws through the holes 172 into mounting flanges 202. The vented bulkhead 198 is shaped to define a ventilation slot 204 alignable with the air intake slot 194 in the body 79 when the vented bulkhead 198 is mounted thereto. A plurality of vent holes 206 disposed through the vented bulkhead 198 aid with air circulation to the display means 74 and enhance dissipation of internally-generated heat. A plurality of standoffs 208 are fastened to the vented bulkhead 198 to receive a motherboard (see FIG. 8B) and mezzanine board (not shown). A shrouded folded fin heatsink 210 having a contact surface 211 is shaped for insertion into the ventilation slot 204 to direct air flowing through the air intake slot 194 upwardly or downwardly (depending on fan direction), causing air flow through the air intake slot 194 to follow a generally upward or downward path. The heatsink 210 includes four brackets 212 along edges thereof that may be fitted to the edges 214 of the vented bulkhead 198 that define the ventilation slot 204, although alternative fastening means may be used. By maneuvering the heatsink 210 into the slot 204, the brackets 212 may be aligned to immobilize the shroud 210 within the slot 204 to channel air flow within the enclosure 78. The heatsink 210 may then be removed to access the display means 74 for maintenance or repairs as necessary. When installed over the air intake slot 194, the contact surface 211 contacts the primary processor 22 (not shown) mounted to a motherboard 216 (see FIG. 8B). Heat transfers from the primary processor 22 through the contact surface to the fins 213, whereby air flowing through the heatsink 210 contacts the fins 213 to receive the heat and transfer it to outside the enclosure 76.

As shown in FIG. 8B, the motherboard 216 provides electrical connectivity between the components described with reference to FIG. 2 through FIG. 5. For simplicity, only the major components are shown in FIG. 8B, such as the GPS receiver 94, the wireless networking module 96, cellular data module 98, and SATA connector 218 for access to removable non-volatile storage 64. The motherboard 216 is shaped to define a ventilation slot 220 that facilitates air flow through the interior of the enclosure 78 (see FIG. 8A). In the first alternative embodiment, the primary processor (not shown) and video capture processor (not shown) are mounted to the motherboard 216.

A mezzanine board 222 securable to the standoffs 208 (see FIG. 8A) provides additional electrical connectivity between the components of the system 51. The vehicle interface array 82 and sensory interface array 84 are fixed to the mezzanine board 222 and surrounded by a gasket 225 to inhibit air from escaping the enclosure 78 through the connector ports 184 disposed in the ribbed back panel 180. The connector ports 184 are positioned to align with the vehicle connector array 82 and sensory interface array 84 when assembled. The mezzanine board 222 is shaped to define a fan slot 224 to receive the fan 182 and facilitate air flow between the mezzanine board 222 and motherboard 216 for cooling. By minimizing locations of the enclosure 78 where air can escape, air exiting the heat sink 210 is forced in a generally U-shaped path between the mezzanine board 222 and motherboard 216 formed by the ventilation slot 220.

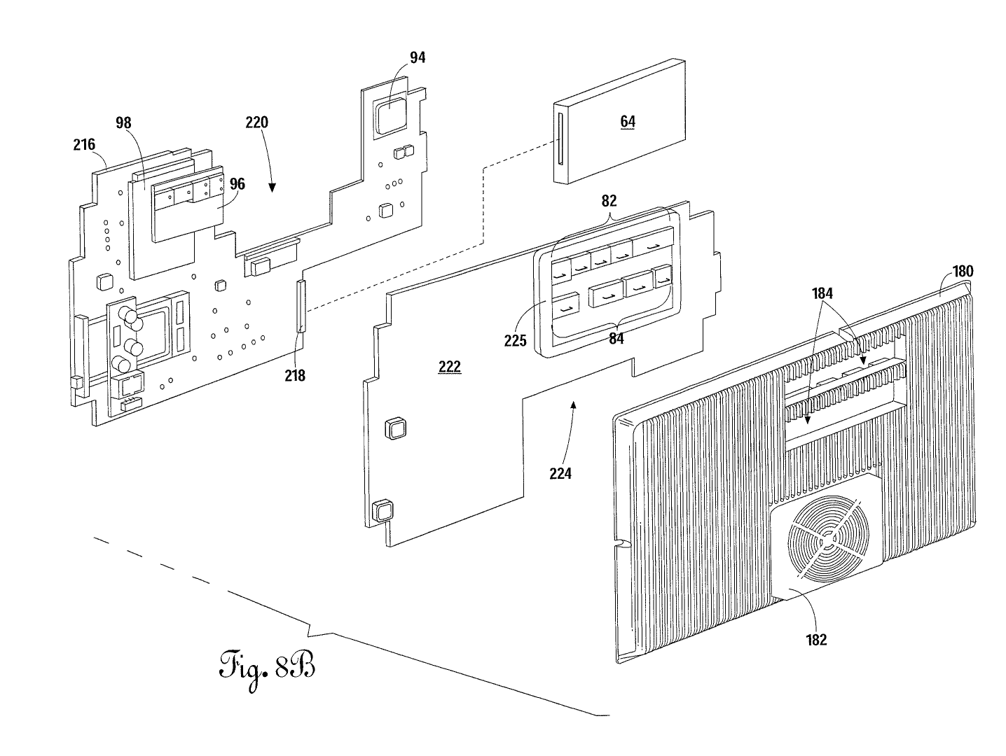

In addition to the system described herein, the present invention further provides a method of displaying at least one video stream received from at least one video input device, as disclosed in the flowchart of FIG. 9A and flow diagram of FIG. 9B. When describing the method with reference to the figures, reference to components of the system is made as if the method is performed by the first alternative embodiment described herein.

A first graphics input stream 57 is received 226 from the A/V input device 59, such as a digital camera or analog camera in combination with an analog-to-digital converter, into the video capture subsystem 58. The first graphics input stream 57 will typically be the recordation of some event such as a traffic stop or high speed chase. The first graphics input stream 57 is then stored 228 in non-volatile memory 62 as first graphics input data 230.

The recorded event may then be viewed when desired by retrieving 232 the first graphics input data 230 and providing 234 that data 230 as a first graphics output stream 236 representative of the first graphics input data 230 to the display multiplexer subsystem 72. Depending on what the responder desires to see displayed, the first graphics output stream 238 may then be selectively displayed 240 on the display means 74 defining a portion of the exterior surface 76 of the enclosure 78 (see FIG. 6). By receiving the first graphics input stream 57 into the video capture subsystem 58, which is a processing-intensive step, the primary processing subsystem 52 (see FIG. 2) is left to handle the administrative and other functions of the system 51, such as general purpose input/output and communications via the cellular and other wireless transceivers.

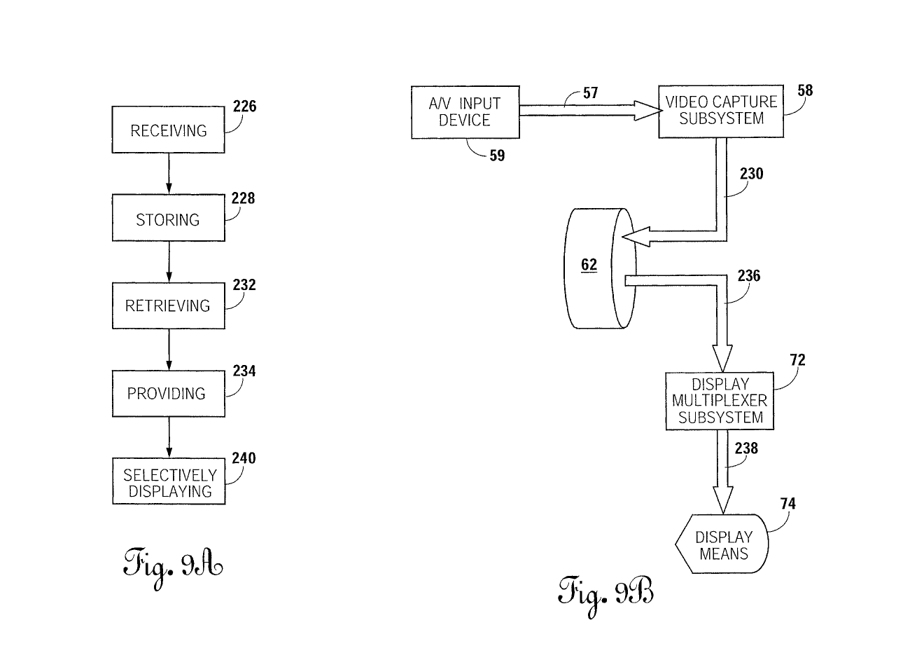

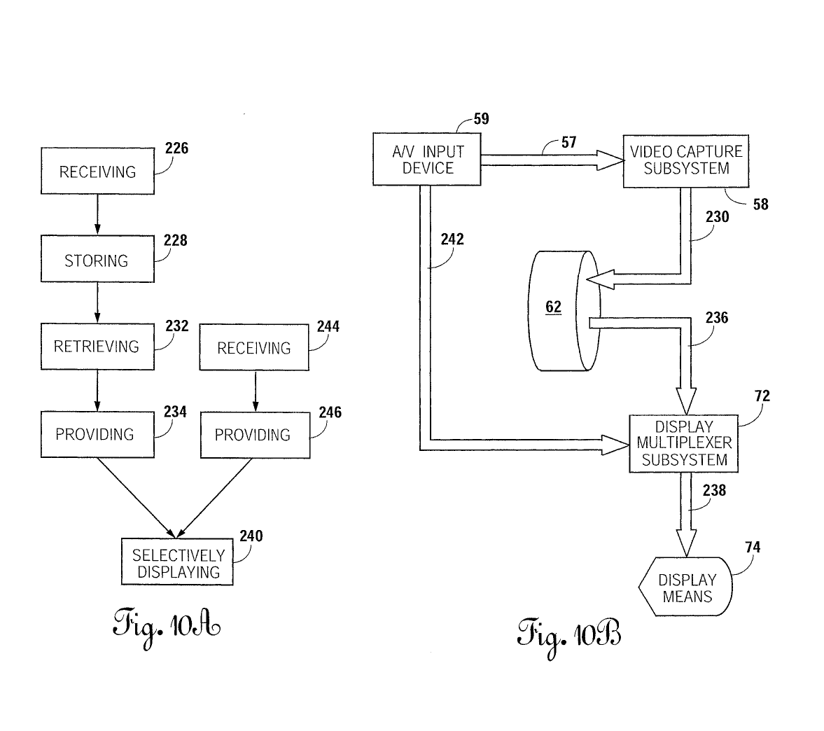

FIG. 10A and FIG. 10B disclose yet another aspect of the invention—that is, displaying a graphics stream representative of one or both of two input graphics streams. The initial steps of the method are as disclosed with reference to FIG. 9A and 9B. In addition, however, a second graphics input stream 242 is received 244 into the system from an A/V input device 59 and is then provided 246 to the display multiplexer subsystem 72. Thereafter, according to the preference of the user, the third graphics output stream 238 provided to the display means 74 comprises at least a portion of the second graphics input stream 242.

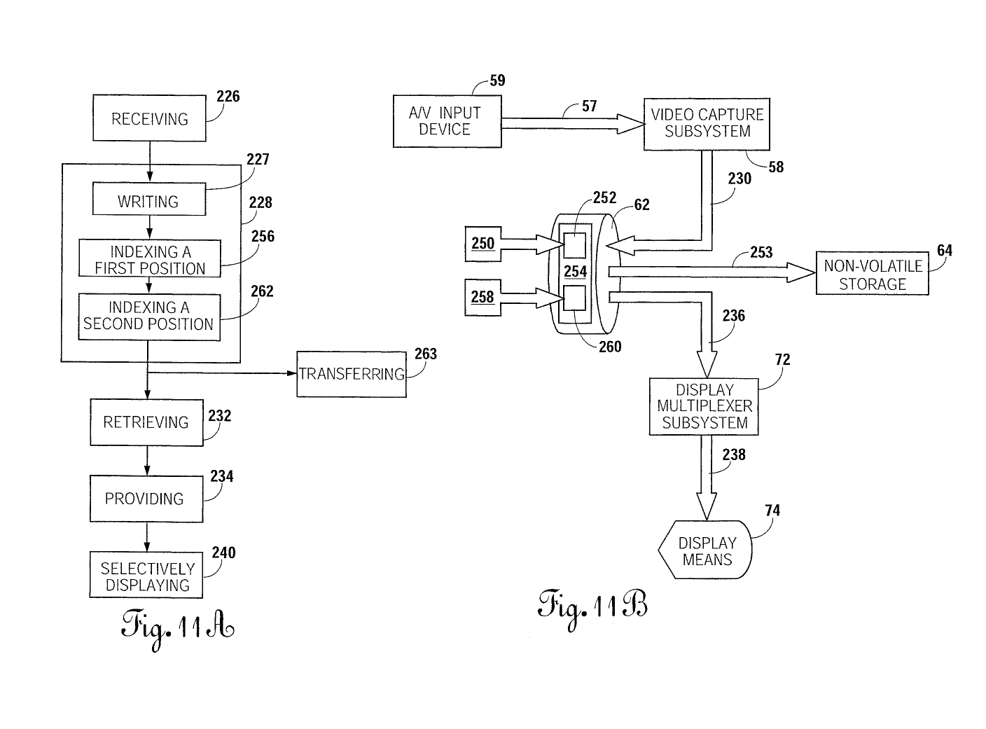

FIG. 11A and FIG. 11B disclose yet another aspect of the present invention wherein the occurrence of events relative to when the first graphics input stream 57 is received and is indexed relative to the first graphics input data 230. For example, as the first graphics input stream 57 is received 226 and written 227 to memory, the occurrence of a first event 250 (e.g., the activation of a cruiser's light bar) is detected by a sensory interface array 84 (not shown), and a first position 252 within a circular buffer 254 within non-volatile memory 62 is indexed 256. Similarly, the occurrence of a second event 258 (e.g., deactivation of a cruiser's light bar) is detected by the sensory interface array 84, and a second position 260 within the circular buffer 254 is indexed 262. Thereafter, the indexed portion 253 of the circular buffer between the first position 254 and second position 260 may be transferred 263 to the non-volatile storage 64 (see FIG. 2) for later archiving and/or removal. In addition to activation and deactivation of a vehicle's light bar, any number of signals may represent the first event 250 or second event 258, including, but not limited to, actuating the vehicle's brakes with a predetermined amount of force, receiving a signal from the cruiser's radar gun representative of another vehicle's unlawful speed, and reception of a remote actuation (or deactivation) signal from an emergency response station via the cellular data interface or wireless networking interface of the system.

Because the buffer 254 is circular, as will be understood by those having ordinary skill in the art, after a time period determined by the size of the video stream and the circular buffer, data will be overwritten by new data received via the video stream. Thus, the non-volatile memory 62 containing the circular buffer 254 is preferably sized to accommodate the maximum possible data amount that can be generated by a received data stream-e.g., the length of an emergency responder's duty shift.

The present invention is described above in terms of a preferred illustrative embodiment of a specifically described system and method, as well as alternative embodiments thereof. Those skilled in the art will recognize that alternative constructions of such a system and implementations of such methods can be used in carrying out the present invention. Other aspects, features, and advantages of the present invention may be obtained from a study of this disclosure and the drawings, along with the appended claims.

I claim:

1. A computer system for use in an emergency response vehicle, the system comprising:
a primary processing subsystem having a primary processor, said primary processing subsystem adapted to provide a first graphics output stream;
a video capture subsystem having a video capture processor and non-volatile memory, said video capture subsystem in communication with said primary processing subsystem and adapted to provide a second graphics output stream;
a storage multiplexer connected to said primary processing subsystem and said video capture subsystem;
a non-volatile storage device accessible by said primary processing subsystem and said video capture subsystem through said storage multiplexer;
a display multiplexer subsystem coupled to said primary processing subsystem and said video capture subsystem for receiving at least two graphics output streams and providing a multiplexed graphics output stream;
an enclosure housing said primary processing subsystem, said video capture subsystem, said storage multiplexer, said display multiplexer subsystem, and said non-volatile storage device; and
display means connected to said display multiplexer subsystem for displaying a multiplexed graphics output stream, said display means defining a portion of the exterior surface of said enclosure.

2. The computer system of claim 1 further comprising a vehicle interface array connected to said primary processing subsystem and adapted to receive user input.

3. The computer system of claim 1 further comprising a sensory interface array connected to said video capture subsystem and adapted to receive sensory input.

4. The computer system of claim 1 further comprising a fingerprint scanner integrated into the exterior surface of said enclosure and connected to said primary processing subsystem.

5. The computer system of claim 1 further comprising a wireless networking module connected to said primary processing subsystem and housed within said enclosure.

6. The computer system of claim 1 further comprising a cellular data module connected to said primary processing subsystem and housed within said enclosure.

7. The computer system of claim 1 further comprising a GPS subsystem connected to said primary processing subsystem and said video capture subsystem and housed within said enclosure.

8. The computer system of claim 1 wherein said primary processing subsystem is in direct communication with said video capture subsystem.

9. The computer system of claim 1 further comprising an audio/visual input device.

10. A computer system for use in an emergency response vehicle, the system comprising:
an enclosure having a body and a ribbed back panel fastenable thereto, said enclosure housing a primary processing subsystem, a video capture subsystem, a storage multiplexer, and a display multiplexer subsystem;
display means for displaying a graphics output stream, said display means defining a portion of the exterior surface of said enclosure;
a vented bulkhead fastened to the interior of said enclosure;
a motherboard fastened to said vented bulkhead, said motherboard having a ventilation slot shaped to facilitate air circulation within said enclosure;
a folded fin heatsink oriented over an air intake slot disposed through said enclosure to receive airflow therefrom or provide airflow thereto, said heatsink having a surface in contact with at least one of said primary processor and said video capture processor;
a fingerprint scanner integrated into the exterior surface of said enclosure; and
a cooling fan fastened to said enclosure and causing air to flow into the interior of said enclosure.

11. The computer system of claim 10 further comprising:
a cellular data module connected to said primary processing module; and
a cellular antenna port coupled to a cellular data module and mounted to the exterior surface of said enclosure.

12. The computer system of claim 10 further comprising:
a wireless networking module connected to said primary processing module; and
a wireless networking antenna coupled to said wireless networking module and mounted to the exterior surface of said enclosure.

13. The computer system of claim 10 further comprising:
a GPS receiver connected to said primary processing module; and
a GPS antenna mounted to the exterior surface of said enclosure and connected to a GPS receiver within said enclosure;

14. The computer system of claim 10 further comprising a removable non-volatile storage device.

15. The computer system of claim 10 further comprising an audio/visual input device.

16. A method of displaying at least one video stream received from at least one audio/visual input device, the method comprising:
receiving a first graphics input stream from a video input device into a video capture subsystem;
storing a first graphics input data representative of said first graphics input stream in a non-volatile memory;
retrieving said first graphics input data from said non-volatile memory with said primary processing subsystem;
providing a first graphics output stream representative of said first graphics input data to a display multiplexer subsystem; and
selectively displaying a third graphics output stream on a display means defining a portion of the exterior surface of an enclosure housing said video capture subsystem, said primary processing subsystem, and said display multiplexer subsystem, wherein said third graphics output stream comprises at least a portion of said first graphics output stream.

17. The method of claim 16 further comprising:
receiving a second graphics input stream from said at least one audio/visual input device into said video capture subsystem;
providing a second graphics output stream representative of said second graphics input stream to said display multiplexer subsystem; and
wherein said third graphics output stream comprises at least a portion of said second graphics input stream.

18. The method of claim 16 wherein:
said first graphics input stream begins on the occurrence of a first event;
said first graphics input stream ends on the occurrence of a second event; and
said storing step further comprises:
writing said first graphics input data to a circular buffer in said non-volatile memory;
indexing a first position within said circular buffer corresponding to the start of said first graphics input stream; and
indexing a second position within said circular buffer corresponding to the end of said first graphics input stream.

19. The method of claim 18 further comprising selectively transferring the contents of said circular buffer to a non-volatile storage housed within said enclosure.
